(19) United States
(12) Patent Application Publication
(10) Pub. No.: US 2005/0012693 A1
(43) Pub. Date: Jan. 20, 2005

(54) Damping and muffling structure for EL cell

(76) Inventors: Chih-Yuan Wang, Taichung Hsien (TW); Yen-Chia Lin, Nantou County (TW); Heng-Yi Chang, Taipei City (TW); Ya-Ling Hsu, Changhua County (TW); Ya-Hui Huang, Pingtung County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/621,421

(22) Filed: Jul. 18, 2003

(51) Int. Cl. G09G 3/30

(52) U.S. Cl. 345/76

(57) ABSTRACT

Damping and muffling structure for EL cell includes a transparent substrate, a front electrode layer and a lighting layer. The front electrode layer and lighting layer are sequentially overlaid on the substrate. An inducing layer and at least one conductive layer are laid on the lighting layer. A back electrode layer is laid on the inducing layer. The conductive layer is laid on the lighting layer in such a position as not to affect light emitting of the lighting region. The conductive layer is also laid on at least one side between both the lighting layer and the inducing layer and connected with the back electrode layer to electrically connect the inducing layer with the back electrode layer. The back electrode layer is connected to a grounding electrode, whereby the conductive layer can quickly remove the charge accumulating on the inducing layer.

### BACKGROUND OF THE INVENTION

The present invention is related to a damping and muffling structure for EL cell, and more particularly to a damping and muffling structure that is able to minify or even eliminate the vibration and noise caused by electromagnetic interference effect created by A.C. electric field.

The conventional electroluminescent cell (EL cell) is a thin sheet and mainly used as backlight cell of PDA, mobile phone, etc. FIG. 5 shows a conventional EL cell composed of a transparent substrate 81, a front electrode layer 82, a lighting layer 83, an inducing layer 84, a back electrode layer 85 and an insulating layer 86. By means of a driving circuit, an AC voltage is applied to the front and back electrode layers 82, 85 to make the lighting layer 83 emit light.

When AC electric field acts on the inducing layer 84, due to electromagnetic interference effect (abbreviated into EMI effect hereafter), the charge will accumulate on the inducing layer 84 to create surface energy conservation effect. The surface energy conservation effect will make the charge uneven distribute on the inducing layer 84 and create piezoelectric effect. The piezoelectric effect will lead to vibration of the EL cell to emit noise. This affects the quality of the EL cell or even interferes with the drive and display of the LCD module.

In order to solve the problems of vibration and noise of the conventional EL cell caused by AC electric field, generally the EL cell is backed to increase the thickness thereof so as to minify the vibration and noise. Alternatively, the EL cell is tightly attached to the circuit board to reduce vibration and noise.

However, the EL cell applied to small-size electronic products such as mobile phones is limited in thickness specification. Therefore, the backing will lead to excessive thickness. On the other hand, the EL cell can be attached to the circuit board to reduce over 60% noise. However, it is difficult to assemble the module and the use of double-face tape will lead to increased cost.

### SUMMARY OF THE INVENTION

It is therefore a primary object of the present invention to provide a damping and muffling structure for EL cell. The damping and muffling structure includes a conductive member that can quickly conduct the charge accumulating on the inducing layer to a grounding electrode so as to minify or even eliminate the vibration and noise caused by AC electric field.

The present invention can be best understood through the following description and accompanying drawings wherein:

### BRIEF DESCRIPTION OF THE DRAWINGS

FIG. 1 is a sectional view of a first embodiment of the EL cell of the present invention;

FIG. 2 is a top view of the first embodiment of the EL cell of the present invention;

FIG. 3 is a plane view of a second embodiment of the present invention;

FIG. 4 is a plane view of a third embodiment of the present invention; and

FIG. 5 is a sectional view of a conventional EL cell.

### DETAILED DESCRIPTION OF THE PREFERRED EMBODIMENTS

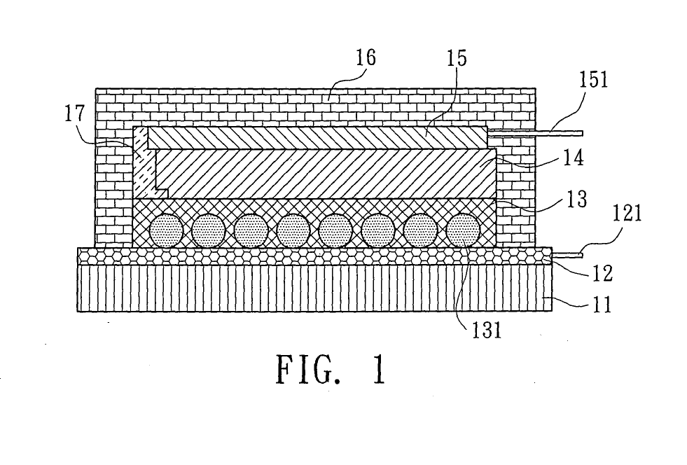

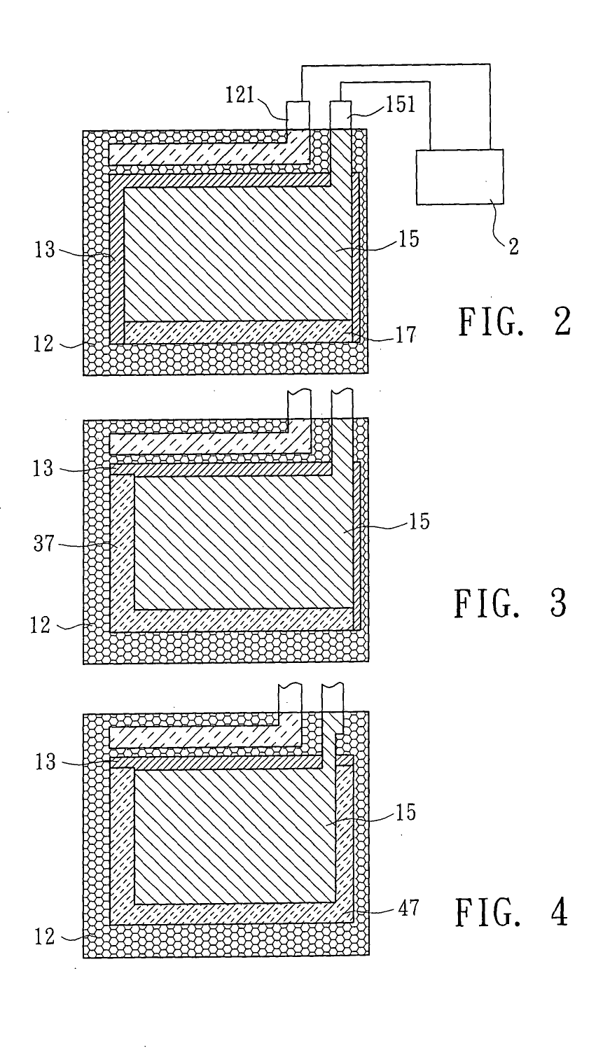

Please refer to FIGS. 1 and 2. The damping and muffling structure for EL cell of the present invention includes a transparent substrate 11, a transparent front electrode layer 12 (which in this embodiment is ITO bus-bar), a lighting layer 13 composed of numerous lighting particles, an inducing layer 14, a back electrode layer 15 and an insulating layer 16 for packaging the EL cell. The transparent front electrode layer 12, lighting layer 13, inducing layer 14, back electrode layer 15 and insulating layer 16 are sequentially overlaid on the substrate 11. The front and back electrode layers 12, 15 are respectively connected with two outward extending conductive terminals 121, 151 for connecting with a driving circuit 2. A conductive layer 17 is laid on the lighting layer 13 in such a position as not to affect light emitting of the lighting region. The conductive layer 17 is not in contact with the front electrode layer 12. The conductive layer 17 is laid on the periphery between both the lighting layer 13 and the inducing layer 14 and connected with the back electrode layer 15 to electrically connect the inducing layer 14 and the back electrode layer 15. The back electrode layer 15 is connected to the grounding electrode of the driving circuit 2, whereby the conductive layer 17 can conduct the charge accumulating on the inducing layer 14.

In this embodiment, only one conductive layer 17 is laid on the lighting layer 13 on one side of the inducing layer 14 without affecting the light emitting of the lighting region of the lighting layer 13. The conductive layer 17 is also laid on the same side between the inducing layer 14 and the back electrode layer 15 to contact with and electrically connect with the back electrode layer 15. The conductive layer 17 can be made of conductive material including silver paste, carbon paste, conductive polymer and metal.

The EL cell can be deemed a capacitor sheet. Therefore, when the driving circuit applies AC voltage between the front electrode layer 12 and the back electrode layer 15 for driving the lighting layer 13 to emit light, due to EMI effect, the charge will accumulate on the inducing layer 14 to create surface energy conservation effect. The surface energy conservation effect will make the charge uneven distribute on the inducing layer 14 and create piezoelectric effect. The piezoelectric effect will lead to vibration of the EL cell to emit noise.

The conductive layer 17 of the present invention is made of conductive material including silver paste, carbon paste, and conductive polymer and metal which is able to conduct the charge. In addition, the back electrode layer 15 electrically connected with the conductive layer 17 is connected to the grounding electrode of the driving circuit 2. Therefore, the charge accumulating on the inducing layer 14 can be quickly conducted to the grounding electrode to weaken the piezoelectric effect caused by the unevenly distributed charge and minify or even eliminate the vibration and noise.

It is shown according to the data of an actual test of this applicant that the EMI value of the conventional EL cell without the conductive member is 1.23V. Under such circumstance, human ears can hear the noise. The EMI value of the EL cell of the present invention is 0.99V. In comparison with the conventional EL cell, the EMI value of the EL cell of the present invention is about 20% reduced. Human ears can hardly hear the noise emitted by the EL cell of the present invention. Therefore, the muffling effect of the present invention is apparent.

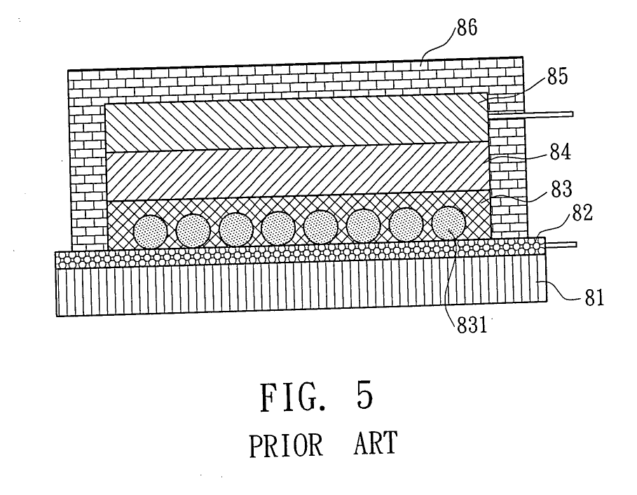

The above embodiment is only used to illustrate the present invention, not intended to limit the scope thereof. Many modifications of the above embodiment can be made without departing from the spirit of the present invention. FIG. 3 shows a second embodiment of the present invention, in which the conductive layer 37 extends to contact with two adjacent sides between the lighting layer 13 and the inducing layer 14. FIG. 4 shows a third embodiment of the present invention, in which the conductive layer 47 encloses and contacts with three sides between the lighting layer 13 and the inducing layer 14. These can achieve the same effect as the first embodiment.

1. A damping and muffling structure for EL cell, comprising a transparent substrate, a front electrode layer, a lighting layer and an insulating layer for packaging the EL cell, the front electrode layer, lighting layer and insulating layer being sequentially overlaid on the substrate, an inducing layer and at least one conductive layer being laid on the lighting layer, a back electrode layer being laid on the inducing layer, the conductive layer being laid on the lighting layer in such a position as not to affect light emitting of the lighting region, the conductive layer being also laid on at least one side between both the lighting layer and the inducing layer and connected with the back electrode layer, the front and back electrode layers being connected with a driving circuit, the back electrode layer being connected to a grounding electrode of the driving circuit, whereby the conductive layer can conduct the charge accumulating on the inducing layer.

2. The damping and muffling structure for EL cell as claimed in claim 1, wherein the conductive layer is made of conductive material including inorganic metal, organic conductive material and organic/inorganic complex conductive material.

3. The damping and muffling structure for EL cell as claimed in claim 1, wherein the conductive layer is laid on the lighting layer on one side of the inducing layer without affecting the light emitting of the lighting region of the lighting layer, the conductive layer being also laid on the same side between the inducing layer and the back electrode layer to contact with and electrically connect with the back electrode layer without contacting with the front electrode layer.

4. The damping and muffling structure for EL cell as claimed in claim 1, wherein the front and back electrode layers are respectively connected with two outward extending conductive terminals for connecting with the driving circuit.
